(19) United States
(12) Patent Application Publication
(10) Pub. No.: US 2025/0008398 A1
(43) Pub. Date: Jan. 2, 2025

(54) COMMUNICATION RELATED TO HANDOVER

(71) Applicant: LG ELECTRONICS INC., Seoul (KR)

(72) Inventors: Ki-Dong LEE, Seoul (KR); Hyunsook KIM, Seoul (KR)

(73) Assignee: LG ELECTRONICS INC., Seoul (KR)

(21) Appl. No.: 18/710,514

(22) PCT Filed: Dec. 16, 2022
(86) PCT No.: PCT/KR2022/020538

§ 371 Date: May 15, 2024

Related U.S. Application Data
(60) Provisional application No. 63/290,592, filed on Dec. 16, 2021.

(51) Int. Cl. H04W 36/08; H04W 36/00; H04W 36/38

(52) U.S. Cl. CPC H04W 36/08; H04W 36/0058; H04W 36/38

(57) ABSTRACT

There is provided a method for performing communication. The method performed by a source BS comprises: receiving UE's first preference information related to one or more neighboring BSs from the UE; receiving neighboring BS's second preference information related to one or more UEs including the UE from a neighboring BS; and performing handover decision for the UE; and transmitting handover request message to a target BS, wherein the target BS is determined based on both of the UE's first preference information and the neighboring BS's second preference information.

### CROSS-REFERENCE TO RELATED APPLICATION(S)

This application is the National Stage filing under 35 U.S.C. 371 of International Application No. PCT/KR2022/020538, filed on Dec. 16, 2022, which claims the benefit of U.S. Provisional Application No. 63/290,592 filed on Dec. 16, 2021, the contents of which are all hereby incorporated by reference herein in their entireties.

### TECHNICAL FIELD

The present disclosure relates to mobile communication.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

In prior art, when the UE that has an ongoing traffic session (e.g., ongoing call) needs to connect to anew base station (BS), the serving BS determined a target BS based on the UE's measurement data. That is, conventionally, the selection of a new BS was made via unilateral decision-making. In other words, the decision was made only based on UE's perspectives (such as measurement, or measurement-based prediction information) but not considering the target BS's perspectives (such as how much the BS prefers to accommodate this request) before making the decision to select the BS as the UE's target BS. Thus, the selection of the target BS can only be optimal from the UE's perspectives, but not necessarily from the target BS's perspective as well.

For example, when an incorrect matching is performed in an overlapping coverage area in which the UE can select one or more of multiple BSs, an opportunity to achieve optimal performance may be lost, and bad effects that increase non-preferred factors such as interference may occur.

### SUMMARY

Accordingly, a disclosure of the present specification has been made in an effort to solve the aforementioned problem.

In accordance with an embodiment of the present disclosure, a disclosure of the present specification provides a method for performing communication. The method may be performed by a source BS and comprise: performing handover decision for the UE. A target BS may be determined based on a UE's preference information and/or a neighboring BS's preference information.

In accordance with an embodiment of the present disclosure, a disclosure of the present specification provides a method for performing communication. The method may be performed by a UE and comprise: transmitting preference information to a source BS; and performing handover procedure.

According to a disclosure of the present disclosure, the above problem of the related art is solved.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIGS. 4 and 5 show an example of protocol stacks in a 3GPP based wireless communication system to which implementations of the present disclosure is applied.

FIG. 6 illustrates an example of a reference diagram for IAB-architectures.

FIG. 7 illustrates an example of a mobile base station relay.

FIG. 8 illustrates an example of a system model with multiple UEs and multiple RAN nodes.

FIGS. 9a and 9b illustrates an example of operations of intra-AMF/UPF handover procedure.

FIGS. 10a to 10c illustrates an example of the proposed method for Intra-AMF/UPF Handover.

FIG. 11 illustrates an example of timing diagram of collecting UE's preference information.

FIG. 12a illustrates an example of preference information of three UEs. FIG. 12b illustrates an example of preference information of three candidate gNBs.

FIG. 13 illustrates an example of a parent-node and a child-node relationship for IAB-node.

FIG. 14 illustrates an example of delivery/transfer of preference information when HO is initiated.

FIG. 15 illustrates an example of operations of a UE and BSs according to the present disclosure.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. Evolution of 3GPP LTE includes LTE-A (advanced), LTE-A Pro, and/or 5G NR (new radio).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDDCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

Although user equipment (UE) is illustrated in the accompanying drawings by way of example, the illustrated UE may be referred to as a terminal, mobile equipment (ME), and the like. In addition, the UE may be a portable device such as a notebook computer, a mobile phone, a PDA, a smart phone, a multimedia device, or the like, or may be a non-portable device such as a PC or a vehicle-mounted device.

Hereinafter, the UE is used as an example of a wireless communication device (or a wireless device, or a wireless apparatus) capable of wireless communication. An operation performed by the UE may be performed by a wireless communication device. A wireless communication device may also be referred to as a wireless device, a wireless device, or the like.

A base station, a term used below, generally refers to a fixed station that communicates with a wireless device. The base station may be referred to as another term such as an evolved-NodeB (eNodeB), an evolved-NodeB (eNB), a BTS (Base Transceiver System), an access point (Access Point), gNB (Next generation NodeB), etc.

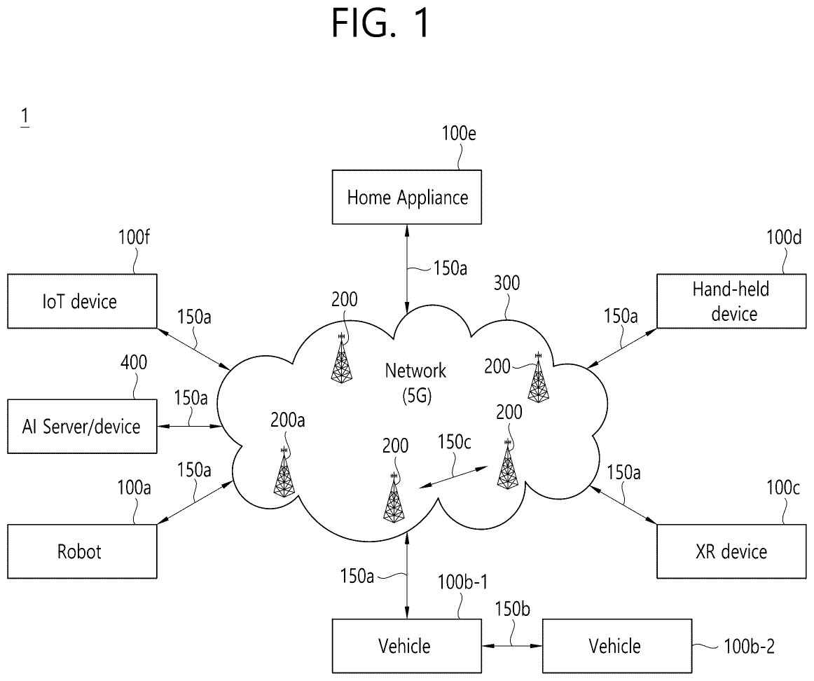

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least apart of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through computer graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple subcarrier spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW). FR2 may include FR 2-1 and FR 2-2 as shown in Examples of Table 1 and Table 2.

TABLE 1

| Frequency Range | | Corresponding | | |
|---|---|---|---|---|
| designation | | frequency range | Subcarrier Spacing | |
| FR1 | | 450 MHz-6000 MHz | 15, 30, 60 | kHz |
| FR2 | FR2-1 | 24250 MHz-52600 MHz | 60, 120, 240 | kHz |
| | FR2-2 | 57000 MHz-71000 MHz | 120, 480, 960 | kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | | Corresponding | | |
|---|---|---|---|---|
| designation | | frequency range | Subcarrier Spacing | |
| FR1 | | 410 MHz-7125 MHz | 15, 30, 60 | kHz |
| FR2 | FR2-1 | 24250 MHz-52600 MHz | 60, 120, 240 | kHz |
| | FR2-2 | 57000 MHz-71000 MHz | 120, 480, 960 | kHz |

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

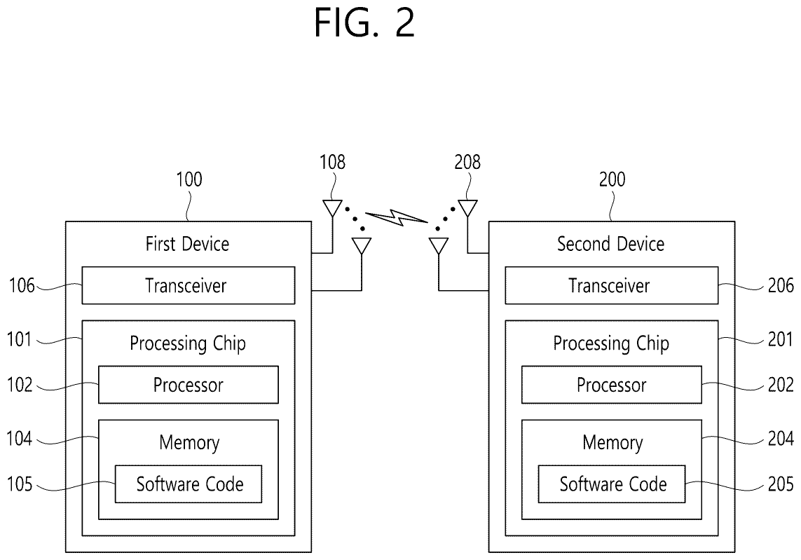

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR).

In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. It is exemplarily shown in FIG. 2 that the memory 104 is included in the processing chip 101. Additional and/or alternatively, the memory 104 may be placed outside of the processing chip 101.

The processor 102 may control the memory 104 and/or the transceiver 106 and may be configured to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with radio frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. It is exemplarily shown in FIG. 2 that the memory 204 is included in the processing chip 201. Additional and/or alternatively, the memory 204 may be placed outside of the processing chip 201.

The processor 202 may control the memory 204 and/or the transceiver 206 and may be configured to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

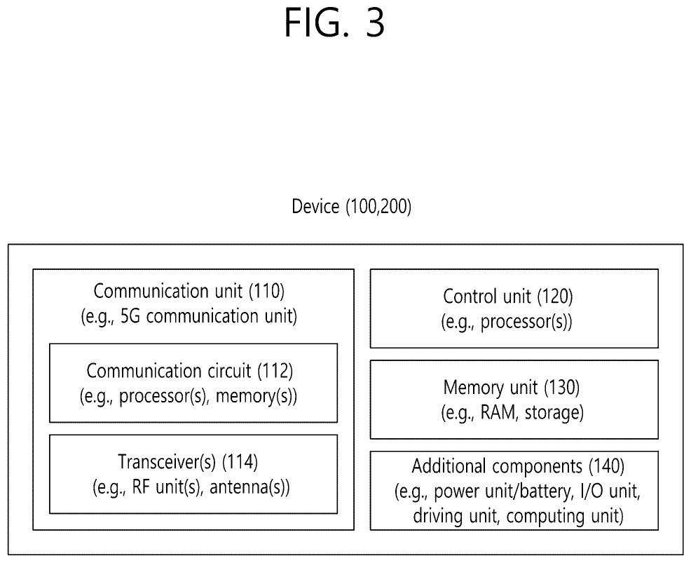

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory unit 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory unit 130 may be configured by a RAM, a DRAM, a ROM, a flash memory, a volatile memory, a non-volatile memory, and/or a combination thereof.

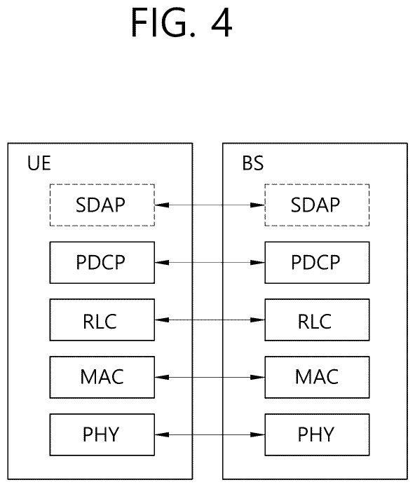

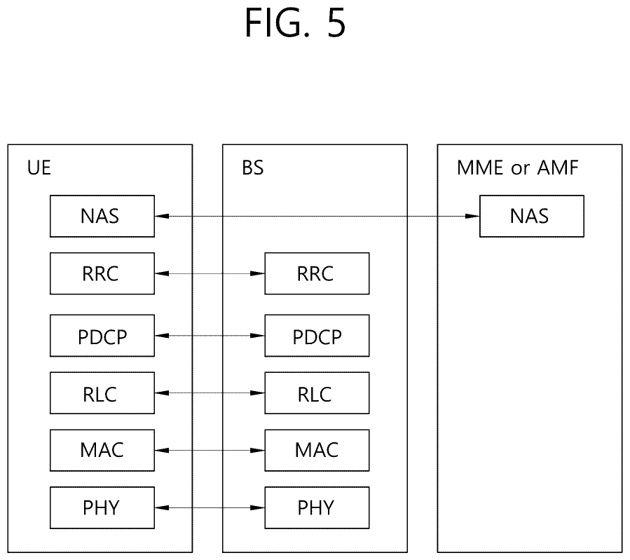

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

### Disclosure of the Present Specification

A VMR may be Vehicle-Mounted Relay or Mobile Base Station Relay. VMR may mean a mobile version of IAB-node mounted in a vehicle.

An Integrated Access and Backhaul (IAB)-node may mean RAN node that supports wireless access to UEs and wirelessly backhauls the access traffic.

An IAB-donor may mean a RAN node which provides UE's interface to core network and wireless backhauling functionality to IAB-nodes.

RAN may be Radio Access Network.

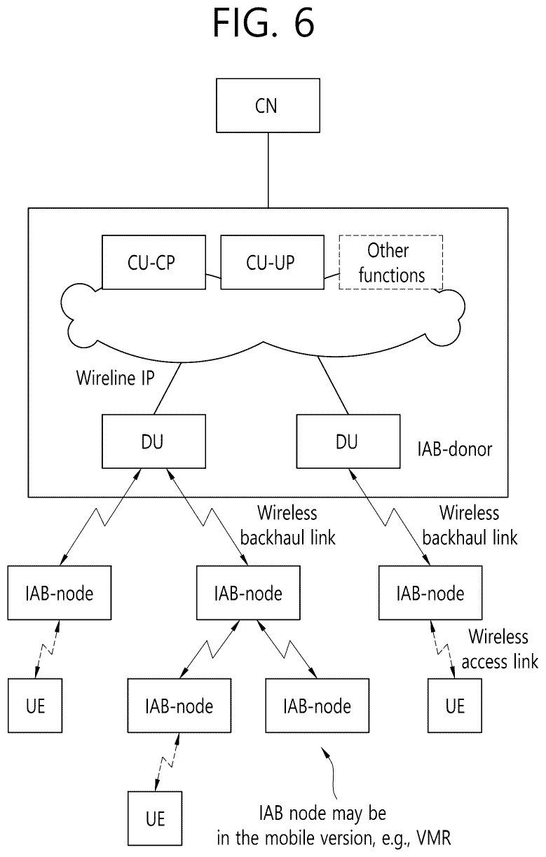

For example, VMR concept overview is shown in FIG. 6

The following drawings are prepared to explain a specific example of the present specification. Since the names of specific devices or names of specific signals/messages/fields described in the drawings are provided by way of example, technical features of the present specification are not limited to specific names used in the following drawings.

FIG. 6 illustrates an example of a reference diagram for IAB-architectures.

The basic concept of VMR may be a mobile version of IAB, of which concept is described in 3GPP TR 38.874 V16.0.0 (for the reference model for Standalone (SA) mode, please refer to the example shown in FIG. 6).

FIG. 6 shows an example of IAB architectures. The IAB-donor is connected to Core Network (CN). IAB-donors may be connected with IAB-nodes based on wireless backhaul link. IAB-node may also be connected with other IAB-nodes. IAB-nodes in FIG. 6 may be implemented in mobile version, such as VMR.

The related service and feature requirements are described in 3GPP TR 22.839 V18.0.0. The high-level concept of VMR is as follows: Demand for improved 5G cellular coverage and connectivity continues to increase, which may be challenging in many outdoor and mobility scenarios. In some outdoor environments, the availability of vehicles equipped with mobile base station relays, either following a certain known/predictable itinerary (e.g. buses, trams, etc), or situated in convenient locations (e.g. outside stadiums, hot-spot areas, or emergency sites), could provide very opportunistic boost to cellular coverage and capacity when/where needed. Those relays, using 5G wireless backhaul toward the macro network, could indeed offer better 5G coverage and connectivity to neighboring UEs.

Vehicle relays are obviously very suitable also for improving connectivity for users or devices inside the vehicle itself, in different environments, e.g. for passengers in buses, car/taxi, or trains, ad-hoc/professional personnel or equipment.

Yet other target scenarios are where vehicle relays can be used for reaching users or devices that would otherwise have no macro coverage or very poor macro coverage. For example, these cases may be cases of first responders dislocated in indoor buildings/areas, using 5G relays placed on their nearby/outside vehicles to get required 5G coverage and connectivity.

The technical benefits of using vehicle relays include, among others, the ability of the BS relay to get better macro coverage than a nearby UE. For example, the technical benefits of using vehicle relays may include exploiting better RF/antenna and power capabilities. Besides the value for network operators and end users, worthy incentives could be found for other parties as well. For example, the other parties may include vehicles manufacturers, vehicle/fleet owners or providers, to install and operate relays in their vehicles.

From a high-level 5G system point of view, the target scenarios may include moving vehicles equipped with small on board base station (BS) relays providing 5G coverage and communication to UEs (inside the vehicle and/or in its vicinity), and connected wirelessly to the 5G network via RAN (donor) nodes.

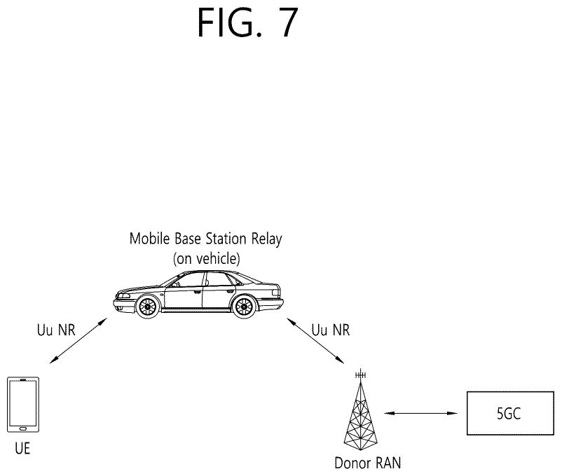

FIG. 7 shows a high-level concept of the VMR but in the System Model considered in the present disclosure, the RAN node that a UE is attempting to access can be MBSR (as in this FIG. 7, or VMR) or can also be an eNB or gNB (without using any intermediate relay).

The following drawings are prepared to explain a specific example of the present specification. Since the names of specific devices or names of specific signals/messages/fields described in the drawings are provided by way of example, technical features of the present specification are not limited to specific names used in the following drawings.

FIG. 7 illustrates an example of a mobile base station relay.

FIG. 7 shows an example of high-level concept of MBSR (or VMR). The UE may be can be connected with the MBSR (or VMR) based on Uu NR interface. The MBSR (or VMR) may be connected with the donor RAN node, which is connected to 5GC, based on Uu NR interface.

A system model and examples of problems to be solved based on the present disclosure may be explained.

The system model considered in this document is as follows. In the system, there are multiple UE's that are looking for VMRs (or MBSR, eNBs or gNB) to initiate a connection with. This initiation can be the initiation of a new session or the initiation of handover request to that targeted RAN node (which can be VMR, MBSR, eNB or gNB). Also, in the system, there are multiple RAN nodes for those UEs can attempt to initiate a session with.

The following drawings are prepared to explain a specific example of the present specification. Since the names of specific devices or names of specific signals/messages/fields described in the drawings are provided by way of example, technical features of the present specification are not limited to specific names used in the following drawings.

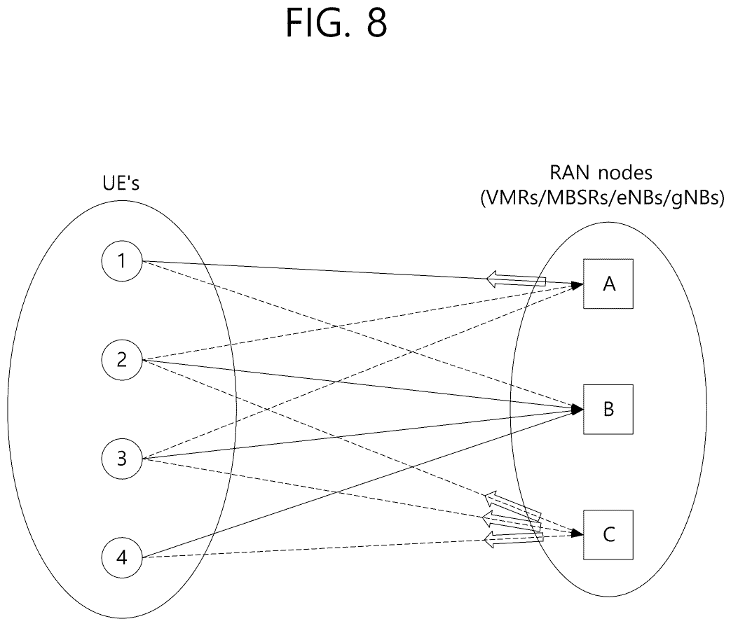

FIG. 8 illustrates an example of a system model with multiple UEs and multiple RAN nodes.

Refer to FIG. 8, an example of the system model is shown.

In FIG. 8, system model with multiple UE's and multiple RAN nodes (e.g., VMRs, gNBs, etc) is shown. The arrow from a UE to a RAN node means that this particular UE has an intent to attempt to access the indicated RAN node (e.g., VMR, MBSR, eNB or gNB). The solid arrow for each UE means the most preferred RAN node by that UE, namely, each UE is most likely to attempt to access that RAN node instead of other RAN nodes that this UE has a dotted arrow(s).

Prior Solutions for Selecting the Best VMR (or MBSR, eNB, or gNB) will be described. It is considered that a system with M UE's and N RAN nodes (i.e., VMRs, MBSRs, eNBs or gNBs in any possible combination). Each UE, say UE i, will make a choice of a RAN node in order to maximize certain objective function (e.g., benefit function) subject to certain constraint(s). Herein, M may mean a number of UE. N may mean a number of RAN nodes.

For a matching problem in the given system with M UEs and N RAN nodes, a linear objective function with a decision matrix X=[xᵢⱼ] may be considered.

Where xᵢⱼ=1 if UE i selects RAN node j to attempt to initiate a session and xᵢⱼ=0 otherwise.

Likewise, we also introduce weight matrix w=[wᵢⱼ] which is considered given. For example, wᵢⱼ may represent the quality of traffic channel (or signal-to-noise-plus-interference ratio and so on) for a given UE i to transmit and receive data traffic with RAN node j measured or predicted at the time that the UE should begin to make a decision to select the best feasible RAN node. (Note that there are various kinds of objective functions that can be used, such as “fairness” of providing transmission opportunity of various kinds, such as max-min fairness, proportional fairness, etc.).

For example, the UE may select a RAN node based on solving the following example. Under this examples of setting, each UE i only needs to solve the following problem, which has a trivial solution with a random tie-breaking rule. For example, the UE may solve the following equation 1.

$$( {P}_{i} ) max {\sum }_{j = 1}^{N} {w}_{ij} {x}_{ij} \qquad [ Equation 1 ]$$

The equation 1 is intended to describe the objective to maximize the score by selecting the best counterpart j with respect to UE (or node) i. The maximization problem should satisfy the constraint condition, which is Σⱼ₌₁^{N}xᵢⱼ≤1, meaning that UE i can only select one counterpart at most (however, by replacing the value in the right-hand side, for example, by 2 or n, it is possible for UE i to select up to 2 or n counterpart(s)), where the control variables (or decision variables) included in the equation 1 are binary decision variable, which is either zero or one, or mathematically xᵢⱼ∈{0,1}, ∀j.

Drawback 1: (Delay and Computational Burden until the current attempt is accepted by a candidate “mate”) Despite the simplicity of obtaining the optimal solution for problem (Pi) of Equation 1, the UE i is exposed to the possibility that it has to continue to solve another problem, say (Pᵢ⁽¹⁾) to select the next best RAN node if the best chose RAN node, say node j′, cannot accommodate the initiation request received from UE i due to some reasons. For example, this node j′ is overloaded or UE i is not sufficiently qualified or eligible to use node j′ under the given condition at that moment in time. the mentioned another problem may be based on Equation 2.

$$( {P}_{i}^{( 1 )} ) max {\sum }_{j = 1 , j \neq j ′}^{N} {w}_{ij} {x}_{ij} \qquad [ Equation 2 ]$$

The equation 2 should satisfy the constraint condition, which is Σ_{j=1,j≠j}^{N}, xᵢⱼ≤1. Variables included in the equation 2 may be based on xᵢⱼ∈{0,1}.

If this type of rejection happens, it also comes with certain length of delay until the second attempt to the next best RAN node is accepted. If the second attempt fails, a third attempt should also be made which causes an extra delay to happen, or even the session has severe disruption. To sum up, the UE needs to solve similar problem repeatedly until the choice of the next best RAN succeeds.

Example: In FIG. 8, for UE 4, RAN node B is the best (the most preferred) node to get connected but due to some reason, the RAN node B may not accept the request from the UE 4; next, the UE 4 should attempt to get connected to RAN node C, which was successful.

Drawback 2: Consider a case that the k-th attempt to a RAN node is successful, which means there are (k−1) components of delays that were caused by the previous (k−1) rejections. For any given k, the following is true: for UE i, the solution that it chose by solving (Pi) at the k-th iteration may be optimal for the UE i (assuming that the situation does not change even after the sum of those delay components). However, it does not mean the matching is still optimal for the RAN node that was selected by UE i and that accepted UE i's request. Therefore, despite the iterative method, the solution that is considered the best is not the best solution in the system. For example, it may not be the best solution for the RAN node (e.g., BS), and/or the core network.

Drawback 3: The prior art regarding mating request (namely, cell selection (or VMR selection) for call initiation or handover initiation, prediction-based or not) is unilateral decision making, requested/triggered by a UE (Service Robot). And, the decision is made by the gNB (or base station, or VMR) in which the decision is binary, i.e., accommodation or rejection, utilizing the standard procedure described as in 3GPP Technical Specifications. Although the mating request from a UE is accommodated in the gNB which the UE thought is the best gNB, it does not necessarily mean that the best matching is achieved as the mating (accommodation) can be considered optimal with respect to that UE only but not necessarily optimal with respect to the whole system operation (i.e., it can still be better for this UE to be accommodated in another gNB which this UE hasn't thought the best).

Examples of method proposed in the present disclosure will be described.

In 3GPP, there are two types of handovers supported: X2-based handover (HO) and Si-based handover. The X2-based HO procedure is a simpler type of HO (namely, HO is negotiated between two gNBs (or eNBs) with no need of MME/AMF direct involvement in that negotiation and decision if both gNBs (or eNBs) are within the same MME/AMF). The X2-based HO procedure typically would be used when an X2 interface exists between the source gNB/eNB and the target gNB/eNB. That is to say, the HO is negotiated directly between the two gNBs; when the UE context is established on the target gNB, the AMF/MME is notified in order to switch the path. When no X2 interface exists between nodes, the Si-based procedure will be utilized with signaling between the target gNB and source gNB passing through the AMF/MME.

The following drawings are prepared to explain a specific example of the present specification. Since the names of specific devices or names of specific signals/messages/fields described in the drawings are provided by way of example, technical features of the present specification are not limited to specific names used in the following drawings.

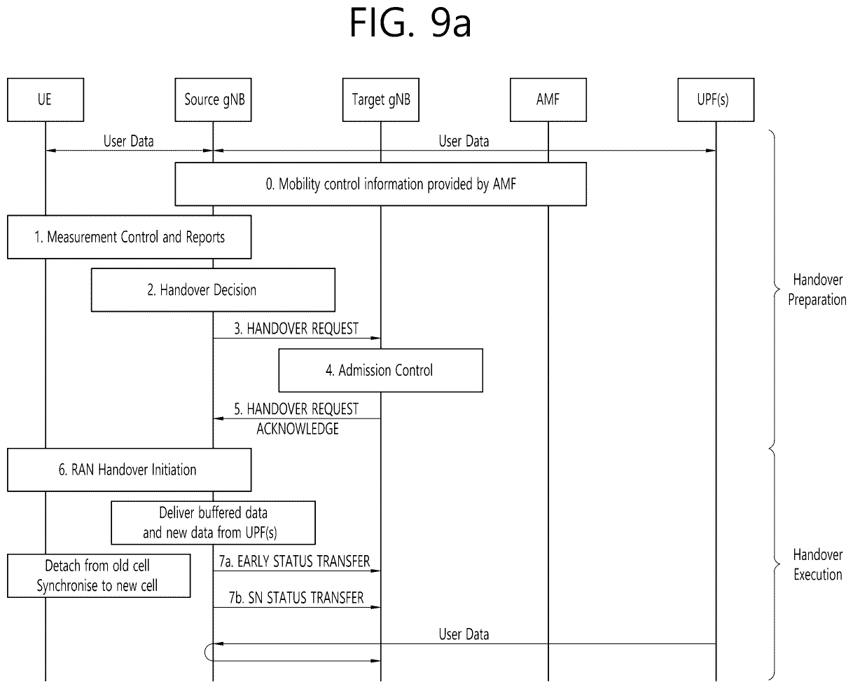

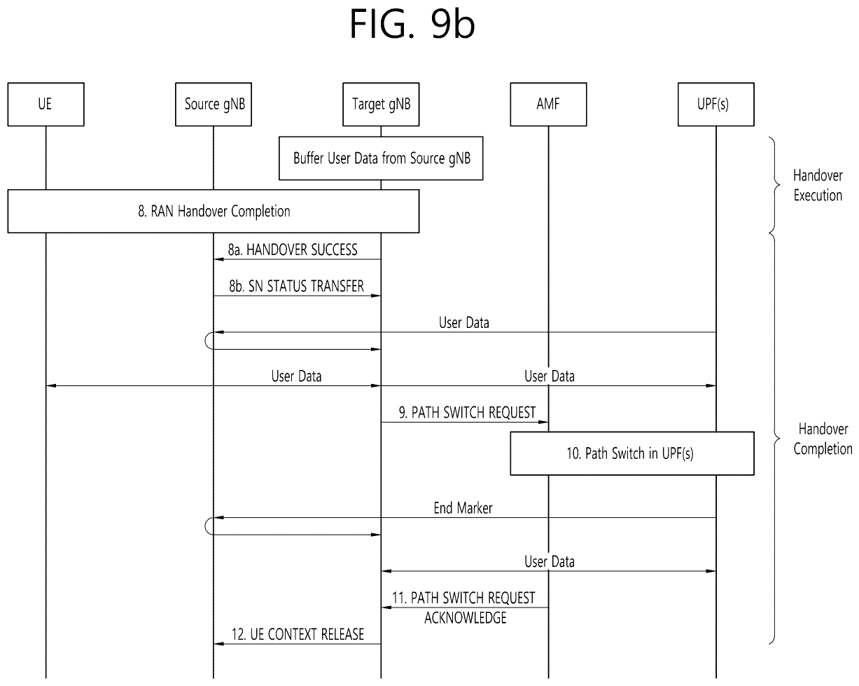

FIGS. 9a and 9b illustrates an example of operations of intra-AMF/UPF handover procedure.

FIGS. 9a and 9b shows example of the X2-based HO procedure.

The intra-NR RAN handover performs the preparation and execution phase of the handover procedure performed without involvement of the 5GC, i.e. preparation messages are directly exchanged between the gNBs. The release of the resources at the source gNB during the handover completion phase is triggered by the target gNB. The figure below depicts the basic handover scenario where neither the AMF nor the UPF changes:

0. The UE context within the source gNB contains information regarding roaming and access restrictions which were provided either at connection establishment or at the last Tracking Area (TA) update.

1. The source gNB may configure the UE measurement procedures and the UE may report according to the measurement configuration. For example, the source gNB may transmit measurement configuration to the UE. The UE may perform measurement based on the measurement configuration. The UE may report a measurement result to the source gNB.

2. The source gNB may decide to handover the UE, based on MeasurementReport and RRM information.

3. The source gNB issues a Handover Request message to the target gNB passing a transparent RRC container with information to prepare the handover at the target side. For example, the source gNB may transmit the Handover Request message to the target gNB. The information includes at least the target cell ID, K_{gNB}*, the Cell Radio Network Temporary Identifier (C-RNTI) of the UE in the source gNB, RRM-configuration including UE inactive time, basic AS-configuration including antenna Info and DL Carrier Frequency, the current QoS flow to DRB mapping rules applied to the UE, the SIB1 from source gNB, the UE capabilities for different RATs, PDU session related information, and can include the UE reported measurement information including beam-related information if available. K_{gNB}* may mean a security key generated by the UE and/or the serving gNB. For example, the security key may be used for a handover procedure to authenticate the UE. The PDU session related information includes the slice information and QoS flow level QoS profile(s). The source gNB may also request a DAPS handover for one or more DRBs.

NOTE 1: After issuing a Handover Request, the source gNB should not reconfigure the UE, including performing Reflective QoS flow to DRB mapping.

4. Admission Control may be performed by the target gNB. Slice-aware admission control shall be performed if the slice information is sent to the target gNB. If the PDU sessions are associated with non-supported slices the target gNB shall reject such PDU Sessions.

5. The target gNB prepares the handover with L1/L2 and sends the HANDOVER REQUEST ACKNOWLEDGE to the source gNB, which includes a transparent container to be sent to the UE as an RRC message to perform the handover. The target gNB also indicates if a DAPS handover is accepted.

NOTE 2: As soon as the source gNB receives the HANDOVER REQUEST ACKNOWLEDGE, or as soon as the transmission of the handover command is initiated in the downlink, data forwarding may be initiated.

NOTE 3: For DRBs configured with DAPS, downlink PDCP SDUs are forwarded with SN assigned by the source gNB, until SN assignment is handed over to the target gNB in step 8b, for which the normal data forwarding follows as defined in S9.2.3.2.3 of 3GPP TS 38.300 V16.7.0.

6. The source gNB triggers the Uu handover by sending an RRCReconfiguration message to the UE, containing the information required to access the target cell: at least the target cell ID, the new C-RNTI, the target gNB security algorithm identifiers for the selected security algorithms. It can also include a set of dedicated RACH resources, the association between RACH resources and SSB(s), the association between RACH resources and UE-specific CSI-RS configuration(s), common RACH resources, and system information of the target cell, etc.

NOTE 4: For DRBs configured with DAPS, the source gNB does not stop transmitting downlink packets until it receives the HANDOVER SUCCESS message from the target gNB in step 8a.

NOTE 4a: CHO cannot be configured simultaneously with DAPS handover.

7a. For DRBs configured with DAPS, the source gNB sends the EARLY STATUS TRANSFER message. The DL COUNT value conveyed in the EARLY STATUS TRANSFER message indicates PDCP SN and HFN of the first PDCP SDU that the source gNB forwards to the target gNB. The source gNB does not stop assigning SNs to downlink PDCP SDUs until it sends the SN STATUS TRANSFER message to the target gNB in step 8b.

7. For DRBs not configured with DAPS, the source gNB sends the SN STATUS TRANSFER message to the target gNB to convey the uplink PDCP SN receiver status and the downlink PDCP SN transmitter status of DRBs for which PDCP status preservation applies (i.e. for RLC AM). The uplink PDCP SN receiver status includes at least the PDCP SN of the first missing UL PDCP SDU and may include a bit map of the receive status of the out of sequence UL PDCP SDUs that the UE needs to retransmit in the target cell, if any. The downlink PDCP SN transmitter status indicates the next PDCP SN that the target gNB shall assign to new PDCP SDUs, not having a PDCP SN yet.

NOTE 5: In case of DAPS handover, the uplink PDCP SN receiver status and the downlink PDCP SN transmitter status for a DRB with RLC-AM and not configured with DAPS may be transferred by the SN STATUS TRANSFER message in step 8b instead of step 7.

NOTE 6: For DRBs configured with DAPS, the source gNB may additionally send the EARLY STATUS TRANSFER message(s) between step 7 and step 8b, to inform discarding of already forwarded PDCP SDUs. The target gNB does not transmit forwarded downlink PDCP SDUs to the UE, whose COUNT is less than the conveyed DL COUNT value and discards them if transmission has not been attempted already.

8. The UE synchronizes to the target cell and completes the RRC handover procedure by sending RRCReconfigurationComplete message to target gNB. In case of DAPS handover, the UE does not detach from the source cell upon receiving the RRCReconfiguration message. The UE releases the source resources and configurations and stops DL/UL reception/transmission with the source upon receiving an explicit release from the target node.

NOTE 6a: From RAN point of view, the DAPS handover is considered to only be completed after the UE has released the source cell as explicitly requested from the target node. RRC suspend, a subsequent handover or inter-RAT handover cannot be initiated until the source cell has been released.

8a/b. In case of DAPS handover, the target gNB sends the HANDOVER SUCCESS message to the source gNB to inform that the UE has successfully accessed the target cell. In return, the source gNB sends the SN STATUS TRANSFER message for DRBs configured with DAPS for which the description in step 7 applies, and the normal data forwarding follows as defined in S9.2.3.2.3 of 3GPP TS 38.300 V16.7.0.

NOTE 7: The uplink PDCP SN receiver status and the downlink PDCP SN transmitter status are also conveyed for DRBs with RLC-UM in the SN STATUS TRANSFER message in step 8b, if configured with DAPS.

NOTE 8: For DRBs configured with DAPS, the source gNB does not stop delivering uplink QoS flows to the UPF until it sends the SN STATUS TRANSFER message in step 8b. The target gNB does not forward QoS flows of the uplink PDCP SDUs successfully received in-sequence to the UPF until it receives the SN STATUS TRANSFER message, in which UL HFN and the first missing SN in the uplink PDCP SN receiver status indicates the start of uplink PDCP SDUs to be delivered to the UPF. The target gNB does not deliver any uplink PDCP SDUs which has an UL COUNT lower than the provided.

9. The target gNB sends a PATH SWITCH REQUEST message to AMF to trigger 5GC to switch the DL data path towards the target gNB and to establish an NG-C interface instance towards the target gNB.

10. 5GC switches the DL data path towards the target gNB. The UPF sends one or more “end marker” packets on the old path to the source gNB per PDU session/tunnel and then can release any U-plane/TNL resources towards the source gNB.

11. The AMF confirms the PATH SWITCH REQUEST message with the PATH SWITCH REQUEST ACKNOWLEDGE message.

12. Upon reception of the PATH SWITCH REQUEST ACKNOWLEDGE message from the AMF, the target gNB sends the UE CONTEXT RELEASE to inform the source gNB about the success of the handover. The source gNB can then release radio and C-plane related resources associated to the UE context. Any ongoing data forwarding may continue.

The RRM configuration can include both beam measurement information (for layer 3 mobility) associated to SSB(s) and CSI-RS(s) for the reported cell(s) if both types of measurements are available. Also, if CA is configured, the RRM configuration can include the list of best cells on each frequency for which measurement information is available. And the RRM measurement information can also include the beam measurement for the listed cells that belong to the target gNB.

The common RACH configuration for beams in the target cell is only associated to the SSB(s). The network can have dedicated RACH configurations associated to the SSB(s) and/or have dedicated RACH configurations associated to CSI-RS(s) within a cell. The target gNB can only include one of the following RACH configurations in the Handover Command to enable the UE to access the target cell:
i) Common RACH configuration;
ii) Common RACH configuration+Dedicated RACH configuration associated with SSB;
iii) Common RACH configuration+Dedicated RACH configuration associated with CSI-RS.

The dedicated RACH configuration allocates RACH resource(s) together with a quality threshold to use them. When dedicated RACH resources are provided, they are prioritized by the UE and the UE shall not switch to contention-based RACH resources as long as the quality threshold of those dedicated resources is met. The order to access the dedicated RACH resources is up to UE implementation.

Upon receiving a handover command requesting DAPS handover, the UE suspends source cell SRBs, stops sending and receiving any RRC control plane signalling toward the source cell, and establishes SRBs for the target cell. The UE releases the source cell SRBs configuration upon receiving source cell release indication from the target cell after successful DAPS handover execution. When DAPS handover to the target cell fails and if the source cell link is available, then the UE reverts back to the source cell configuration and resumes source cell SRBs for control plane signalling transmission.

The proposed examples of the proposed method will be described.

For example, delay efficient method to achieve stable matching for handover between multiple UEs and Multiple gNBs will be explained. When the preferences of respective UEs and the preferences of gNBs are known to a source gNB. For example, Game Theoretic Approach may be used as an example for algorithm when the source gNB performs handover decision according to the present disclosure.

With this being claried as shown in FIGS. 9a and 9b, in the proposed method, the preference information (e.g., the preference vector) received from each UE by a gNB can be utilized to perform either X2-based HO procedure or Si-based HO procedure. In this case, this gNB knows of which gNBs are included in the preference information (e.g., the preference vector) received from each UE.

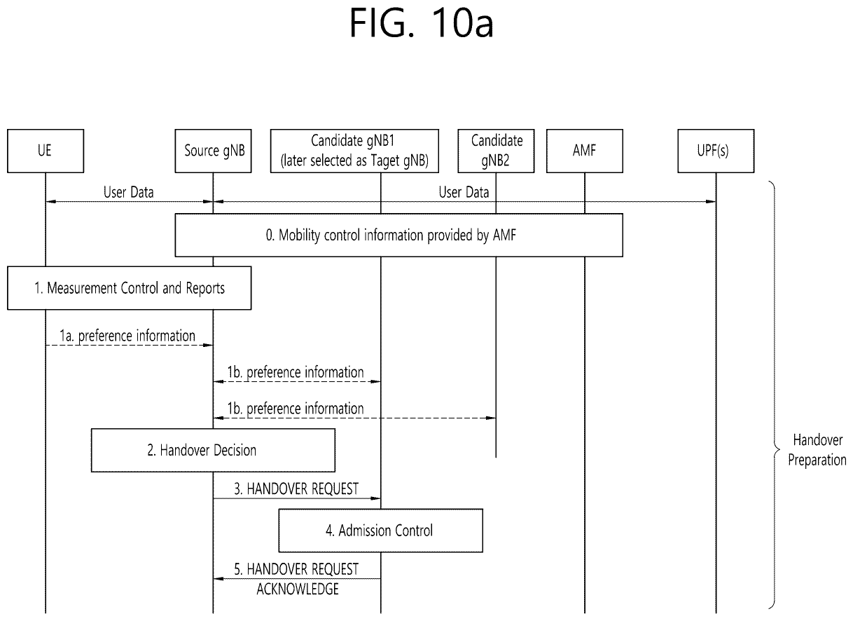

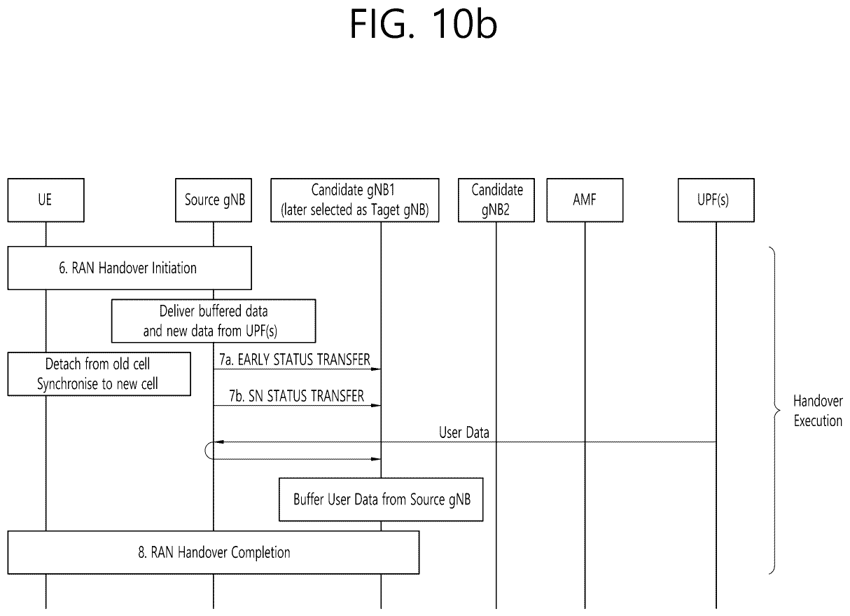

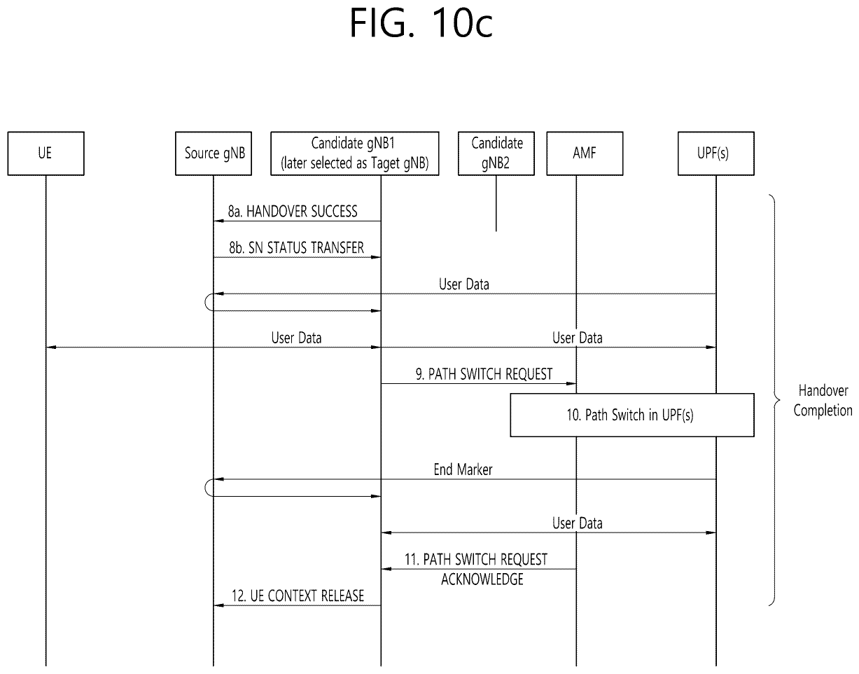

The proposed examples of the proposed method will be described based on FIGS. 10a to 10c.

The following drawings are prepared to explain a specific example of the present specification. Since the names of specific devices or names of specific signals/messages/fields described in the drawings are provided by way of example, technical features of the present specification are not limited to specific names used in the following drawings.

FIGS. 10a to 10c illustrates an example of the proposed method for Intra-AMF/UPF Handover.

FIGS. 10a to 10c show the proposed method for Intra-AMF/UPF Handover using the concept of preference vectors.

In FIGS. 10a to 10c, candidate gNB1 and candidate gNB2 are shown. According to examples based on FIGS. 10a to 10c, candidate gNB1 may be selected as Target gNB by the source gNB.

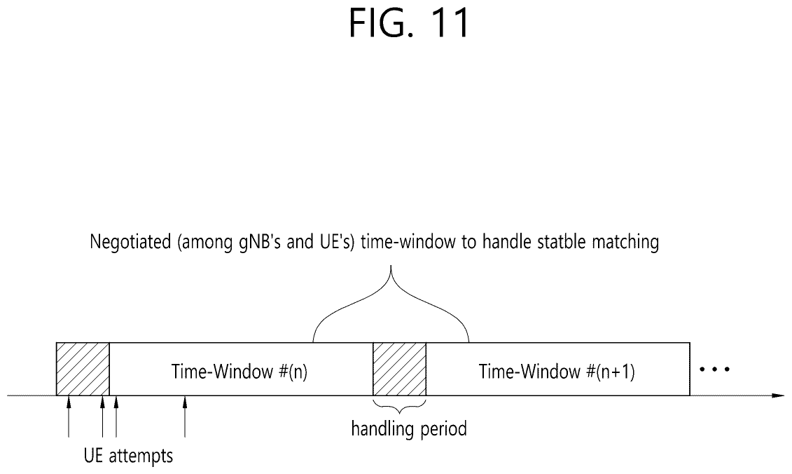

FIGS. 10a to 10c will be described based on differences between the FIGS. 11a/11b and FIGS. 10a/10b. In the following description, the differences between the FIGS. 11a/11b and FIGS. 10a/10b may be mainly described. Similar operations or description already described with respect to FIGS. 10a/10b may not be explained referring to FIGS. 10a to 10c. Even though the operations or descriptions are not explained with FIGS. 10a to 10c, the UE, the source gNB, candidate gNB1, candidate gNB2, AMF, and/or UPF may perform operations already explained in description related to FIGS. 9a and 9b.

1. The source gNB may configure the UE measurement procedures and the UE may report according to the measurement configuration. For example, the source gNB may transmit measurement configuration to the UE. The UE may perform measurement based on the measurement configuration. The UE may report a measurement result to the source gNB.

According to an embodiment of the present disclosure, the followings may be performed during or after step 1 in FIGS. 10a to 10c:

i) UE i may perform measurement and prediction. For reference, UE i may mean UE of FIGS. 10a to 10c.

For example, UE i may use various examples of parameter to perform measurement and/or prediction. The various examples of parameter may include the following:

KL: UE i may measure the signal strength(s) from its surrounding gNB(s), more specifically, the signal strength at geo-location stamp (x(t), y(t)) for time duration [t0, t1] (in which this UE can make multiple measurements during this time period (for example, two times of measurements, or “N” times of measurement with a finer granularity); based on the measurements, the UE can use the statistics to make a prediction using “time-series prediction models”; the prediction result may be the expected signal strength at time t2 (that is, in the near future when this UE should be handed over to some gNB by).
(1) Xa=“signal strength from the candidate gNB (or IAB node)”,
(2) Xa′=“change of signal strength from the candidate gNB (or IAB node)” (which can be obtained by the UE by comparing two or more measurements, or the first derivative of “signal strength from the candidate gNB (or IAB node)”),
(3) Xa″=“speed of change of signal strength from the candidate gNB (or IAB node)” [namely, the second derivative of the “signal strength from the candidate gNB (or IAB node)” over a certain time window], and/or
(4) “rise of thermal” (that is the indicator of the RACH) of the candidate gNB (or IAB node).

The UE can use various types of calculation method for prediction of the relevance level of a candidate gNB (or IAB node). For example, the UE may perform prediction based on a relevance value. For example, the relevance value of a UE may be determined based on an equation, such as “(relevance value of a UE)=(alpha1)*Xa+(alpha2)*Xa′+(alpha3) Xa”. where (alpha1), (alpha2), and (alpha3) are weighting factor for the respective parameter values. The relevance value may mean a level that how appropriate the matching between a UE and a gNB.

ii) The UE i may generate (or build up) preference information. For example, the preference information may include preference vector or may mean the preference vector. The UE i may generate (or build up) the preference information (e.g., the preference vector) which may be a sequence of candidate gNBs, including the information which gNB is preferred the most, next, third, and so on. For the preference information (e.g., the preference vector), the following (a) and (b) may be applied:

(a) When generating (or building up) the preference vector, the UE i may use measurement results and prediction results. When the UE i performs prediction, measurement result and geographic information and road trac information can be used. For example, the UE i performs prediction, based on measurement result and geographic information and road trac information.

(b) The road traffic info can be classified into multiple levels (e.g., heavy, medium, light) and can be combined with a particular geographic information. For example, the particular geographic information may include direction of the road sitting at a specific geographic coordinate measured and/or predicted future coordinate, lane-level information of the road based on detailed geographic coordinate and/or predicted future coordinate. For example, the particular geographic information may include geographical information, road directions, road coordinates, etc. The particular geographic information may be used by the gNB to know what signal quality the UE, which moving on a specific location, have.

iii). UE i may perform the Measurement Control and Reports with preference vector to the Source gNB (or VMR), which is in fact acting as an advising gNB (or counselling gNB) because this gNB will provide some advice in response to the preference vectors that have been received from UE's served by itself as For example, the UE i may transmit the measurement report with the preference vector to the Source gNB(or VMR). For reference, the advising gNB (or the counselling gNB) may mean that the gNB does not make an unilateral decision for selecting a pair of a gNB and a UE, that is, the gNB may consider both of the preference of the UE and the preference of the gNB.

For example, UE i may transmit the preference information (e.g., the preference vector) separately as shown in step 1a of FIGS. 10a to 10c. Step 1a may be performed optionally. UE i may transmit the preference information (e.g., the preference vector) with the measurement result in step 1 or may transmit UE i may transmit the preference information (e.g., the preference vector) separately as shown in step Ta.

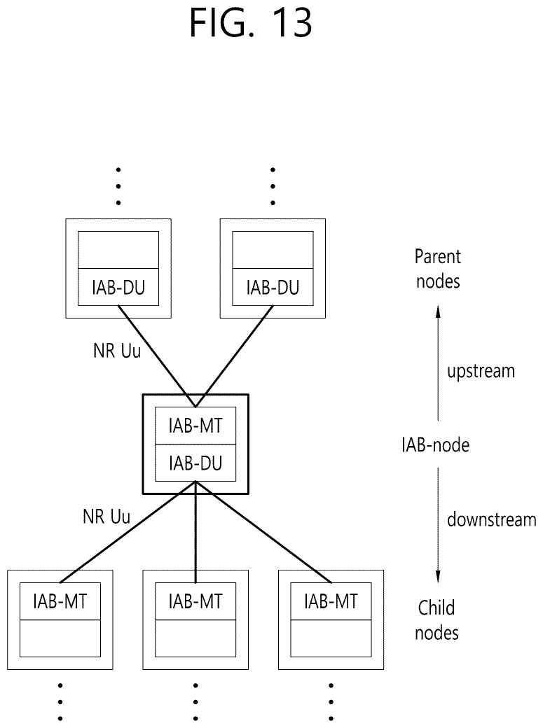

For example, UE i may transmit the preference information (e.g., the preference vector) to the source gNB based on a timing shown in an example of FIG. 13

The following drawings are prepared to explain a specific example of the present specification. Since the names of specific devices or names of specific signals/messages/fields described in the drawings are provided by way of example, technical features of the present specification are not limited to specific names used in the following drawings.

FIG. 11 illustrates an example of timing diagram of collecting UE's preference information.

FIG. 11 shows an example of Timing diagram of timing for collecting UE's HO attempts/requests with preference vector information and timing for handling of those UE attempts. Each “Time-Window” contains a “handling period” at the beginning.

Each UE that requires a HO to be performed may transmit its preference information (e.g., the preference vector). This will happen during a “time-window” (e.g., time-window #(n) for some integer “n”).

Each source gNB (or source IAB node) keeps collecting those attempts from UEs (related to HO request with preference vector information) during the negotiated “time-window”.

As soon as the time-window ends, each source gNB (or source IAB node) should share the preference vector information with neighboring gNBs (and their Child nodes (IAB nodes under the gNB or under the parent IAB node)).

Once received, a gNB (or IAB node) should work on for stable matching and share the outcome with the neighboring gNBs (and their Child nodes (IAB nodes under the gNB or under the parent IAB node)). The stable matching may mean a matching between gNBs and UEs based on considering both of the preference of the UEs and the preference of the gNBs.

Once each source gNB (or source IAB node) receives the “stable matching” information, it should initiate the HO procedure for each UE with the matched target gNB (or IAN node) that is appeared in the shared “stable matching” information.

Description for FIGS. 10a to 10c will be continued.

iv) NOTE: A gNB knows of which gNB's are around itself (i.e., its neighboring gNB's) by reading the preference vectors received from the respective UE's that are served by itself and that require a handover due to some reason.

v) (as shown in step 1b of FIGS. 10a to 10c) A gNB (“Source gNB” in FIGS. 10a to 10c) may share the preference information (e.g., the preference vector) (i.e., preference information of the UE) that have been received from UE's served by itself, with its neighboring gNB's (e.g., candidate gNB1, candidate gNB2). In the same way, the neighboring gNBs of the Source gNB (e.g., candidate gNB1, or candidate gNB2 in FIGS. 10a to 10c) will also share their preference information (e.g., the preference vector) (i.e., preference information of the gNB) that they, respectively, have received, with the Source gNB as in FIGS. 10a to 10c. For example, each gNBs may receive preference information (e.g., preference vector), which indicates which gNBs are preferred by the neighboring UEs, from neighboring UEs, and each gNBs may receive preference information (e.g., preference vector), which indicates which UEs are preferred by the neighboring gNBs,

For example, the source gNB (or source IAB node) may share information, which can be used for its neighboring gNB(s) to determine which candidate gNB is relevant for certain UE(s) to achieve a stable matching for handover. The preference information of the source gNB or preference information of the candidate gNBs may include information that which UEs are preferred by those gNBs, listed in order of the degree of the preference. The source gNB (or source IAB node) may share the type of ongoing traffic session (e.g., HD voice, Over-the-top voice, video session, multimodal session), the degree of mobility (e.g., speed level, such as very fast, medium, or slow to see what the gNB can or should do to accommodate the UE's HO request), and so on. Also, application-layer information can also be used/shared (e.g., the maneuver, travel path (e.g., statistics of moving behavior at a transit center for the source gNB to select/recommend the best gNB (or VMR, mobile IAB node) for the UE)).

For example, refer to FIGS. 11, during the shaded time period, gNBs may share the information collected during the previous time-window.

vi) The Source gNB may perform handover decision (as shown in step 2 of FIGS. 10a to 10c) based on the following description. The Source gNB may perform handover decision by considering all collected preference information (e.g., information vectors) from UEs. The Source gNB shall make a selection of one gNB out of those gNB's that UE i included in its preference information (e.g., the preference vector) (Note: the selected gNB is not necessarily equal to the most preferred gNB that UE i has selected.). The Source gNB may transmit “HANDOVER REQUEST” message to that selected gNB. In FIGS. 10a to 10c, the Source gNB has selected the candidate gNB1 for UE i at Step 2 (Handover Decision), Candidate gNB1 now becomes the Target gNB for UE i as it has been selected for UE i by the Source gNB.

There may be a case in which the “stable candidate gNB” for a particular UE, which is selected by the source gNB for that UE based on the shared information among neighboring gNBs, does not or cannot accommodate (or accept) the HO request from that UE (during time-window #(n+1) as shown in FIG. 11). Herein, the stable candidate gNB may mean a candidate gNB that can be selected as the target gNB based on both preference information of the UE and preference information of the candidate gNBs. For this case, the current source gNB may perform one of the following options:

(Option 1) The source gNB may remove the “currently selected stable candidate gNB” and select a new stable candidate gNB. For example, the source gNB may remove the “currently selected stable candidate gNB” from the game problem, which is an example used for handover decision in FIG. 10a and FIG. 10b, (which is the stable matching problem) and solve to select a new stable candidate gNB.

(Option 2) (1) The source gNB may remove the “currently selected stable candidate gNB” from the game problem (which is the stable matching problem) and solve to select a new stable candidate gNB, (2) The source gNB may share the updated information with neighboring gNB's during the “handling period” within time-window #(n+2), which is a time-window right after the time-window #(n+1) in FIG. 11.

Related to step 2, the source gNB may perform handover decision based on both preference information (e.g., the preference vector) of a UE and preference information (e.g., the preference vector) of a gNB. The following usage examples are examples that the source gNB performs handover decision based on both preference information (e.g., the preference vector) of a UE and preference information (e.g., the preference vector) of a gNB.

There may three UEs, UE x, UE y, and UE z and three candidate gNB's for these UEs, gNB a, gNB b and gNB c.

The following drawings are prepared to explain a specific example of the present specification. Since the names of specific devices or names of specific signals/messages/fields described in the drawings are provided by way of example, technical features of the present specification are not limited to specific names used in the following drawings.

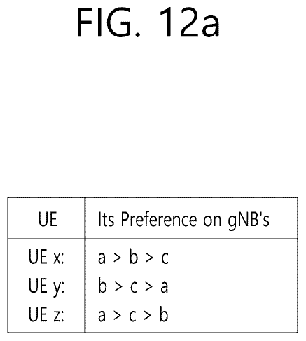

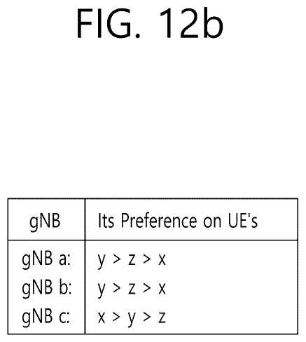

FIG. 12a illustrates an example of preference information of three UEs. FIG. 12b illustrates an example of preference information of three candidate gNBs.

Table shown in FIG. 12a may indicate the preference information (e.g., the preference vectors) of three UEs. For example, UE y prefers gNB b as the best, prefers gNB c as the second, prefers gNB a as the third.

Table shown in FIG. 12b may indicate the preference information (e.g., the preference vectors) of three candidate gNBs. For example, candidate gNB c prefers UE x as the best, prefers UE y as the second, prefers UE z as the third.

In this example, an iterative algorithm proposed by Gale and Shapley in 1962 (refer to The American Mathematical Monthly Vol. 69, No. 1 (January, 1962), pp. 9-15 (7 pages) https://www.eecs.harvard.edu/cs286r/courses/fall09/papers/galeshapley.pdf) may be used by each UE to solve a problem which gNB to contact (e.g., UEs a, b, and c, respectively contacting to make a handover to). It may lead to a certain number of iterations of request and rejection (which is in turn a delay until a suitable matching is made) until a stable matching is achieved or it may lead to an unstable matching (i.e., a UE can be accommodated by a gNB which has had a better candidate UE to accommodate to become more efficient from the point of view of the source gNB (or to be able to provide better connectivity to other UE).

However, as explained in various examples of the present disclosure, if the matching problem is rather looked into by and solved by the Source gNB which also knows of the preference of these candidate gNB's a, b, and c, then it can either avoid the aforementioned delay or avoid unstable matching.

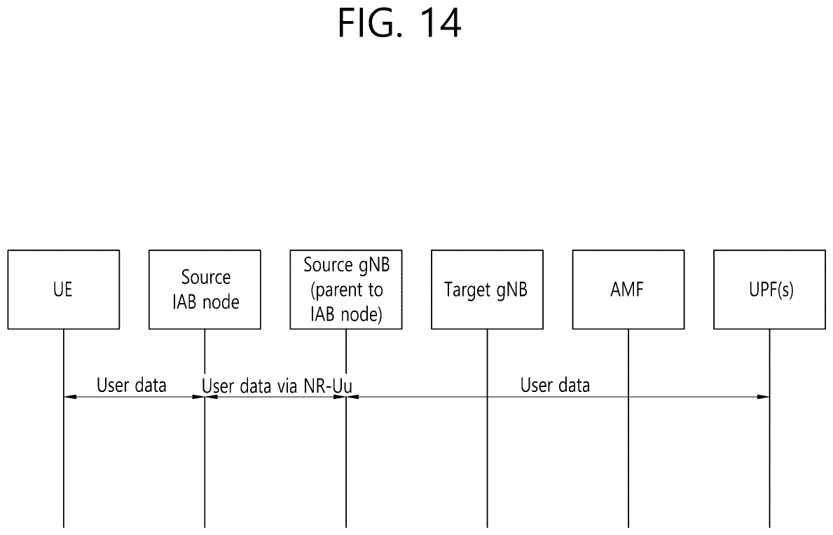

Various examples explained in the present disclosure may also be applied to a use case of employing an IAB node or multiple IAB nodes (or mobile version of IAB, such as Vehicle-mounted Relay or Mobile Base Station Relay). For example, FIG. 13 and FIG. 14 show the examples of the use case of employing an IAB node or multiple IAB nodes.

The following drawings are prepared to explain a specific example of the present specification. Since the names of specific devices or names of specific signals/messages/fields described in the drawings are provided by way of example, technical features of the present specification are not limited to specific names used in the following drawings.

FIG. 13 illustrates an example of a parent-node and a child-node relationship for IAB-node.

MT of IAB-MT may mean Mobile Termination. According to FIG. 13, IAB-nodes may be connected to each other as child nodes and/or parent nodes.

The use of an IAB node (a single-hop extension) or of a series of IAB nodes (a multi-hop extension) has the relationship described in FIG. 13. Namely, the relation of parent-to-child nodes has an NR-Uu interface, and the relation of the next parent-to-child nodes (which are the next generation of the previous (or upper) nodes) also has an NR-Uu interface.

FIG. 14 shows an example for a case in which the UE is connected to source IAB node and the preference information (e.g., preference vector) is to be delivered and/or transferred.

The following drawings are prepared to explain a specific example of the present specification. Since the names of specific devices or names of specific signals/messages/fields described in the drawings are provided by way of example, technical features of the present specification are not limited to specific names used in the following drawings.

FIG. 14 illustrates an example of delivery/transfer of preference information when HO is initiated.

FIG. 14 shows an example of preference vector” delivery/transfer when HO is being initiated.

The UE may transmit preference information (e.g., preference vector) to the Source IAB node as the user data.

The source IAB node delivers (or transmits) the UE's preference information (e.g., preference vector) to the source gNB via NR-Uu interface. Herein, the source gNB is the parent node of the source IAB node.

The source gNB shares the UE's preference information (e.g., preference vector) with candidate target gNB(s) (or candidate IAB node(s) if the target nod is an IAB node, rather than a gNB).

The following drawings are prepared to explain a specific example of the present specification. Since the names of specific devices or names of specific signals/messages/fields described in the drawings are provided by way of example, technical features of the present specification are not limited to specific names used in the following drawings.

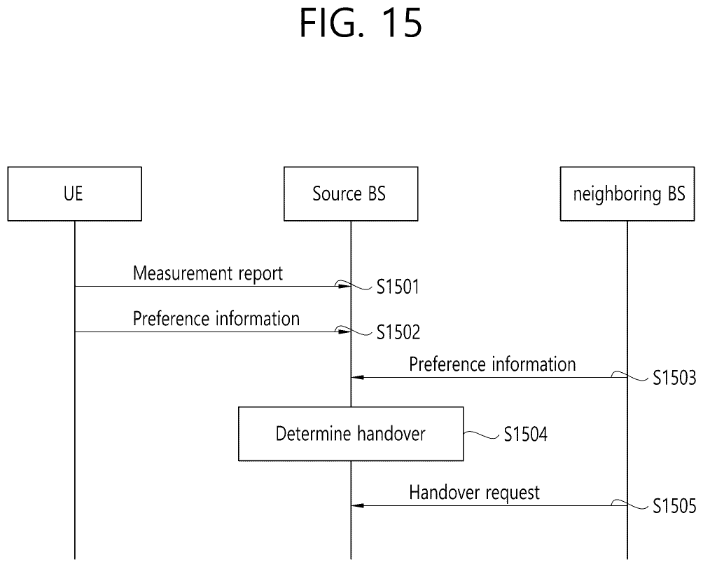

FIG. 15 illustrates an example of operations of a UE and BSs according to the present disclosure.

FIG. 15 shows an example of operations of the UE and the BSs. The UE and/or the BSs may perform operations described in the present specification, even if they are not shown in FIG. 15. Herein, a network may be gNB, base station, serving cell, etc. For reference, gNB, NG-RAN, and BS may be used as a term with same meaning. Neighboring BS of FIG. 15 and candidate BS explained in the present disclosure may mean a same term.

The UE and the network(e.g. Source BS, neighboring BS, target BS, etc.) may perform operations explained above with various examples.

In FIG. 15, one neighboring BS is shown but this is merely an example, the scope of the present disclosure is not limited to FIG. 15.

In step S1501, the UE may transmit measurement report to the source BS. Step S1501 may be performed in a same way with step 1 of FIGS. 10a to 10c.

In step S1502, the UE may transmit first preference information to the source BS. The first preference information may be the UE's preference information including a list of one or more neighboring BSs. Step S1502 may be performed in a same way with step 1a of FIGS. 10a to 10c.

In step S1503, the neighboring BS may transmit preference information to source BS. Step S1503 may be performed in a same way with step 1b of FIGS. 10a to 10c.

In step S1504, the source BS may perform handover decision. For example, the source BS may determine whether to perform handover for the UE and which BS among the one ore more neighboring BSs as a target BS. Step S1504 may be performed in a same way with step 2 of FIGS. 10a to 10c.

In step S1505, the source BS may transmit handover request to the target BS. For reference, the target BS may be same as the neighboring BS shown in FIG. 15 or may be different from the neighboring BS shown in FIG. 15. Step S1505 may be performed in a same way with step 3 of FIGS. 10a to 10c.

Hereinafter, an apparatus (for example, a source BS) in a wireless communication system, according to some embodiments of the present disclosure, will be described.

For example, the apparatus may include at least one processor, at least one transceiver, and at least one memory.

For example, the at least one processor may be configured to be coupled operably with the at least one memory and the at least one transceiver.

For example, the processor may be configured to perform operations explained in various examples of the present specification. For example, the processor may be adapted to perform operations including: transmitting measurement configuration to a UE; receiving measurement report from the UE; receiving UE's first preference information related to one or more neighboring BSs from the UE; receiving neighboring BS's second preference information related to one or more UEs including the UE from a neighboring BS; performing handover decision for the UE; transmitting handover request message to a target BS, wherein the target BS is determined based on both of the UE's first preference information and the neighboring BS's second preference information.

Hereinafter, an apparatus(for example, UE) in a wireless communication system, according to some embodiments of the present disclosure, will be described.

For example, the apparatus may include at least one processor, at least one transceiver, and at least one memory.

For example, the at least one processor may be configured to be coupled operably with the at least one memory and the at least one transceiver.

For example, the processor may be configured to perform operations explained in various examples of the present specification. For example, the processor may be adapted to perform operations including: receiving measurement configuration from a source base station (BS); transmitting measurement report to the source BS; transmitting UE's first preference information related to one or more neighboring BSs to the source BS; and performing handover procedure with a target BS.

Hereinafter, a processor for in a wireless communication system, according to some embodiments of the present disclosure, will be described.

For example, the processor may be configured to perform operations including: receiving measurement configuration from a source base station (BS); transmitting measurement report to the source BS; transmitting UE's first preference information related to one or more neighboring BSs to the source BS; and performing handover procedure with a target BS.

Hereinafter, a non-transitory computer-readable medium has stored thereon a plurality of instructions in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For other example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of a UE to perform operations including: obtaining measurement configuration from a source BS; generating measurement report to the source BS; generating UE's first preference information related to one or more neighboring BSs to the source BS; and performing handover procedure with a target BS.

Hereinafter, an apparatus(for example, base station) in a wireless communication system, according to some embodiments of the present disclosure, will be described.

For example, the apparatus may include at least one processor, at least one transceiver, and at least one memory.

For example, the at least one processor may be configured to be coupled operably with the at least one memory and the at least one transceiver.

For example, the processor may be adapted to perform operations explained in various examples of the present specification. For example, the processor may be adapted to perform operations including: obtaining measurement configuration from a source BS; generating measurement report to the source BS; generating UE's first preference information related to one or more neighboring BSs to the source BS; and performing handover procedure with a target BS.

Advantageous effects which can be obtained through specific embodiments of the present disclosure. For example, when BS needs to be selected for a UE, both UE's aspect and BS's aspect can be considered in a bilateral manner, instead of unilateral manner used in the current technology, so that the best decision made from the BS's perspective which is indeed not the best decision for UE's can be avoided. Namely, unstable matching may be avoided Another example includes delay according to performing signaling due to UE's selection which did not consider the BS's aspect can be avoided.

In the above exemplary systems, although the methods have been described on the basis of the flowcharts using a series of the steps or blocks, the present disclosure is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present disclosure.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method for performing communication, the method performed by a source Base Station (BS) and comprising:
transmitting measurement configuration to a User Equipment (UE);
receiving measurement report from the UE;
receiving UE's first preference information related to one or more neighboring BSs from the UE;
receiving neighboring BS's second preference information related to one or more UEs including the UE from a neighboring BS;
performing handover decision for the UE;
transmitting handover request message to a target BS,
wherein the target BS is determined based on both of the UE's first preference information and the neighboring BS's second preference information.

2. The method of claim 1,
wherein the first preference information includes a list of the one or more neighboring BSs in the order preferred by the UE.

3. The method of claim 1,
wherein the second preference information includes a list of the one or more UEs in the order preferred by the neighboring BS.

4. The method of claim 1, further comprising:
determining source BS's preference information based on at least one UEs.

5. The method of claim 4,
wherein the target BS is determined based on the UE's first preference information, the source BS's preference information and the neighboring BS's second preference information.

6. The method of claim 4,
wherein the source BS's preference information is determined based on the type of ongoing traffic session, the degree of mobility, and/or application-layer information

7. (canceled)

8. A method for performing communication, the method performed by a User Equipment (UE) and comprising:
receiving measurement configuration from a source base station (BS);
transmitting measurement report to the source BS;
transmitting UE's first preference information related to one or more neighboring BSs to the source BS; and
performing handover procedure with a target BS.

9. The method of claim 8, further comprising:
performing measurement and/or prediction for one or more neighboring BSs; and
determining the UE's first preference information based on the measurement and/or the prediction.

10. A User Equipment (UE) in a wireless communication system, the UE comprising:
at least one transceiver;
at least one processor; and
at least one computer memory operably connectable to the at least one processor and storing instructions that, based on being executed by the at least one processor, perform operations comprising:
receiving measurement configuration from a source base station (BS);
transmitting measurement report to the source BS;
transmitting UE's first preference information related to one or more neighboring BSs to the source BS; and
performing handover procedure with a target BS.

11. The UE of claim 10,
wherein the UE is an autonomous driving device that communicates with at least one of a mobile terminal, a network, and an autonomous vehicle other than the UE.

12-13. (canceled)
